(19) United States
(12) Patent Application Publication
(10) Pub. No.: US 2008/0267521 A1
(43) Pub. Date: Oct. 30, 2008

(54) MOTION AND IMAGE QUALITY MONITOR

(75) Inventors: Jiang Gao, Sunnyvale, CA (US); C. Phillip Schloter, San Francisco, CA (US); Kari Pulli, Palo Alto, CA (US); Matthias Jacob, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/770,452

(22) Filed: Jun. 28, 2007

Related U.S. Application Data
(60) Provisional application No. 60/913,761, filed on Apr. 24, 2007.

(51) Int. Cl. G06K 9/40

(52) U.S. Cl. 382/254

(57) ABSTRACT

A method, apparatus and computer program product for monitoring the motion and/or image quality associated with a captured image are provided. Various actions may be taken in response to the detected motion and corresponding image quality associated with a captured image. In particular, the motion and image quality monitor may, for example, only allow captured images to be used in conjunction with an image matching application, such as a mobile visual search application, when the image features of the captured image have stabilized (i.e., little to no motion is detected between consecutive frames of the captured image). The detected changes in motion and/or image quality may further be used for energy saving purposes, for example, by switching on or off various applications and/or components operating on the mobile device depending upon the amount of motion detected and/or the quality of the image captured.

### CROSS-REFERENCE TO RELATED APPLICATIONS

This application claims priority to U.S. Provisional Patent Application Ser. No. 60/913,761 filed Apr. 24, 2007, which is hereby incorporated by reference.

### FIELD

Exemplary embodiments of the present invention relate, generally, to motion and image quality monitoring and, in particular, to a technique for improving image matching and/or providing power savings through motion and image quality monitoring.

### BACKGROUND

With the wide use of mobile phones having cameras, camera applications are becoming more and more popular for mobile phone users. As a result, mobile applications based on image matching or recognition including, for example, what is referred to as a mobile visual search, are emerging. One such application is the visual search system described in U.S. application Ser. No. 11/592,460, entitled “Scalable Visual Search System Simplifying Access to Network and Device Functionality,” the contents of which are hereby incorporated herein by reference in their entirety.

Unlike keyword searches, visual search systems are typically based on analyzing the perceptual content of a media object or media content, such as images or video data (e.g. video clips), using an input sample image as the query. The visual search system is different from the so-called image search commonly employed by the Internet, where keywords entered by users are matched to relevant image files on the Internet. Visual search systems are typically based on sophisticated algorithms that are used to analyze a media object, such as an input image (e.g., an image captured by a user using a camera operating on his or her mobile phone) against a variety of image features or properties of the image such as color, texture, shape, complexity, objects and regions within an image. To facilitate efficient visual searches, the images along with their properties, and other metadata associated with the images, are usually indexed and stored in a visual database, such as a centralized database that stores predefined point-of-interest (“POI”) images, along with their corresponding features and related metadata (i.e., textual tags). In mobile visual search, the mobile device takes advantage of the large visual database to match against input images. After matching an input image with an image stored in the visual database, the mobile visual search can transmit the context information tagged to the stored image to the user. Based on the foregoing, it is clear that the robustness of an image matching engine used to match the input image to an image of the visual database plays a critical role in a mobile visual search system.

There are special problems, however, with using the camera on a mobile phone for applications based on image matching, such as mobile visual searching. For example, one of the major problems is the quality of the input images. Due to the form factor and spontaneous nature of imaging applications on a mobile device, motion is a problem and can substantially reduce the input image quality (referred to as “motion blur”). This, in turn, will affect the performance of image matching applications. Experimental results show that motion blurring is one of the major factors that limit the image matching performance on a mobile device.

Another problem comes from user experience. Due to hand motion and other image noises, image matching results can “flip over,” or change, repeatedly, thus providing a poor user experience. In particular, when moving a phone, a recognition engine may return wrong results due to motion blur and other artifacts.

A need, therefore, exists, for a way to ensure that poor image quality caused, for example, by movement or changes in environmental conditions, does not detrimentally affect the application of various image matching applications, such as mobile visual search applications.

### BRIEF SUMMARY

In general, exemplary embodiments of the present invention provide an improvement over the known prior art by, among other things, providing a way to monitor the motion and/or image quality associated with a captured image being used, for example, in conjunction with various image matching or recognition applications, such as a mobile visual search application. According to exemplary embodiments of the present invention, a monitor can detect changes in image quality and, for example, only allow the captured image to be used in conjunction with an image matching application (e.g., a visual search application) when the image features have stabilized. One result of requiring that only stabilized images be used in a visual search application is that the user's experience is greatly improved by reducing the number of times the application “flips over” or provides a different result. According to other exemplary embodiments, detected changes in motion and/or image quality may be used for energy saving purposes, for example, by switching on and off various applications and/or components operating on the mobile device depending upon the amount of motion detected and/or the quality of the image captured.

According to one aspect, a method is provided of monitoring motion and image quality of a captured image. In one embodiment, the method may include: (1) detecting motion in a captured image; and (2) taking an action in response to the motion detected, wherein the action includes either stabilizing the captured image prior to using the captured image in an image matching application or conserving power in response to the motion detected exceeding a predetermined threshold.

In one exemplary embodiment, detecting motion in a captured image involves comparing one or more features of two or more consecutive frames of the captured image. Comparing the features may, in turn, involve: (1) sampling two or more frames of the captured image; (2) filtering the two or more sampled frames to remove noise; (3) extracting the one or more features from the sampled frames; and (4) computing a difference between the extracted features of the sampled frames. In one exemplary embodiment, comparing the one or more features of the two or more consecutive frames of the capture image may further involve dividing respective sampled frames into two or more sub-regions, wherein filtering the two or more sampled frames comprises filtering respective sub-regions of the samples frames, extracting one or more features from the sample frames comprises extracting one or more features from respective sub-regions of the sampled frames, and computing a difference between the extracted features comprises computing the difference between extracted features for respective sub-regions of the sampled frames. The method of this exemplary embodiment may further include accumulating the computed difference between extracted features for respective sub-regions and integrating the accumulated differences of the two or more sub-regions.

According to another aspect, an apparatus is provided for monitoring motion and image quality of a captured image. In one exemplary embodiment, the apparatus includes a processor and a memory in communication with the processor and storing an application executable by the processor. The application may, in one exemplary embodiment, be configured, upon execution, to detect motion in a captured image and to cause an action to be taken in response to the motion detected, wherein the action includes either stabilizing the captured image prior to using the captured image in an image matching application or conserving power in response to the motion detected exceeding a predetermined threshold.

According to yet another aspect, a computer program product is provided for monitoring motion and image quality of a captured image. The computer program product may include at least one computer-readable storage medium having computer-readable program code portions stored therein. In one exemplary embodiment, the computer-readable program code portions include: (1) a first executable portion for detecting motion in a captured image; and (2) a second executable portion for causing an action to be taken in response to the motion detected, wherein the action includes either stabilizing the captured image prior to using the captured image in an image matching application or conserving power in response to the motion detected exceeding a predetermined threshold.

In accordance with another aspect, an apparatus is provided for monitoring motion and image quality of a captured image. In one exemplary embodiment, the apparatus includes: (1) means for detecting motion in a captured image; and (2) means for taking an action in response to the motion detected, wherein the action includes either stabilizing the captured image prior to using the captured image in an image matching application or conserving power in response to the motion detected exceeding a predetermined threshold.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of one type of system that would benefit from exemplary embodiments of the present invention;

FIG. 3 illustrates a visual search system that would benefit from exemplary embodiments of the present invention;

FIG. 4 illustrates an entity capable of operating as various servers or devices of a visual search system of exemplary embodiments of the present invention;

FIG. 5 illustrates how the frames of a captured image may be sampled in order to perform the monitoring of exemplary embodiments of the present invention;

FIG. 6 illustrates the sub-regions into which a sampled frame may be divided in accordance with exemplary embodiments of the present invention;

FIG. 7 is a flow chart illustrating the steps which may be taken in order to analyze the image features of the sub-regions of a sampled frame in accordance with an exemplary embodiment of the present invention;

FIG. 8 illustrates how the analysis of respective sub-regions may be integrated in accordance with exemplary embodiments of the present invention; and

FIGS. 9A-9D are flow charts illustrating the actions or responses which may be taken as a result of low/high image quality as detected in accordance with exemplary embodiments of the present invention.

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, exemplary embodiments of the present invention provide a technique for monitoring the motion and image quality of a captured image. Where poor image quality and/or a high degree of motion is detected, various steps or actions can be taken by the mobile device in response. For example, in one exemplary embodiment, where a substantial amount of change is detected between frames of a captured image, indicating, for example, that the quality of the captured image is low, a visual search system of the kind discussed above may be instructed not to update a search query based on the new image frame. In other words, the motion and image quality monitor of exemplary embodiments may be used to ensure that the image used by the visual search, or similar image matching, application is stabilized prior to use. Exemplary embodiments, therefore, reduce the number of times such an application “flips over” or provides new results; thus improving a user's overall experience. In another exemplary embodiment, the motion and image quality monitor may be used for power savings purposes by, for example, causing one or more components of the mobile device, or the device itself, to be turned off in response to motion detected.

The change detected by the motion and image quality monitor may be a result of motion, for example caused by user hand movements, and/or an environmental change, such as lighting. In particular, the motion and image quality monitor may use the same image features as used in image matching to compare sampled frames. As a result, the motion and image quality monitor of exemplary embodiments may not only be used to monitor motions, but also as a general input image quality monitor.

In addition, as discussed in more detail below, the motion and image quality monitor of one exemplary embodiment may be designed to work together with an image matching system in order to minimize the additional computations, and corresponding overhead, needed to perform the motion and image quality monitoring.

The motion and image quality monitor of exemplary embodiments may be implemented on a one-camera, or multiple-camera mobile device, as well as on any other mobile device with any kind of sensor including, but not limited to motion sensors.

### Overall System and Mobile Device:

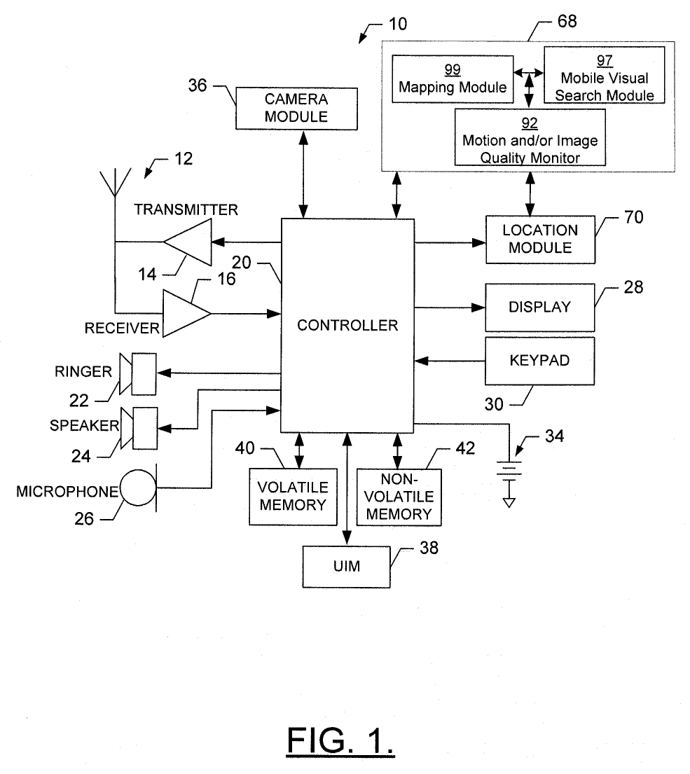

FIG. 1 illustrates a block diagram of a mobile terminal 10 that would benefit from exemplary embodiments of the present invention. It should be understood, however, that the mobile telephone as illustrated and hereinafter described is merely illustrative of one type of mobile terminal that would benefit from the present invention and, therefore, should not be taken to limit the scope of exemplary embodiments of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ exemplary embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of exemplary embodiments of the present invention will be primarily described in conjunction with mobile communications applications. It should be understood, however, that the system and method of exemplary embodiments of the present invention can be utilized in conjunction with a variety of other applications, both in the mobile communications industries and outside of the mobile communications industries.

As shown in FIG. 1, the mobile terminal 10 of one exemplary embodiment may include an antenna 12 in operable communication with a transmitter 14 and a receiver 16. The mobile terminal 10 may further include a controller 20 or other processing element that provides signals to and receives signals from the transmitter 14 and receiver 16, respectively. The signals may include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 may be capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 may include a camera module 36 in communication with the controller 20. The camera module 36 may be any means for capturing an image or a video clip or video stream for storage, display or transmission. For example, the camera module 36 may include a digital camera capable of forming a digital image file from an object in view, a captured image or a video stream from recorded video data. As such, the camera module 36 may include all hardware, such as a lens or other optical device, and software necessary for creating a digital image file from a captured image or a video stream from recorded video data. Alternatively, the camera module 36 may include only the hardware needed to view an image, or video stream while a memory device of the mobile terminal 10 stores instructions for execution by the controller 20 in the form of software necessary to create a digital image file from a captured image or a video stream from recorded video data. In an exemplary embodiment, the camera module 36 may further include a processing element such as a co-processor which assists the controller 20 in processing image data or a video stream and an encoder and/or decoder for compressing and/or decompressing image data or a video stream. The encoder and/or decoder may encode and/or decode according to a JPEG standard format, and the like.

The mobile terminal 10 may further include a location module 70, such as a GPS module, in communication with the controller 20. The location module 70 may be any means for locating the position of the mobile terminal 10. Additionally, the location module 70 may be any means for locating the position of points-of-interest (POIs), in images captured by the camera module 36, such as for example, shops, bookstores, restaurants, coffee shops, department stores and other businesses and the like, as described more fully in U.S. Provisional Application No. 60/913,733 entitled Method, Device, Mobile Terminal and Computer Program Product for a Point of Interest-Based Scheme for Improving Mobile Visual Searching Functionalities” (“the '733 application”), the contents of which are hereby incorporated herein by reference. As such, points-of-interest as used herein may include any entity of interest to a user, such as products and other objects and the like. The location module 70 may include all hardware for locating the position of a mobile terminal or a POI in an image. Alternatively or additionally, the location module 70 may utilize a memory device of the mobile terminal 10 to store instructions for execution by the controller 20 in the form of software necessary to determine the position of the mobile terminal or an image of a POI. Additionally, the location module 70 may be capable of utilizing the controller 20 to transmit/receive, via the transmitter 14/receiver 16, locational information such as the position of the mobile terminal 10 and a position of one or more POIs to a server, such as the visual map server 54 (also referred to herein as a visual search server) and the point-of-interest shop server 51 (also referred to herein as a visual search database), described more fully below.

The mobile terminal of one exemplary embodiment, may also include a unified mobile visual search/mapping client 68 (also referred to herein as visual search client) for the purpose of implementing a mobile visual search, for example, of the kind discussed above. The unified visual search client 68 may include a mapping module 99 and a mobile visual search engine 97 (also referred to herein as mobile visual search module). The unified mobile visual search/mapping client 68 may include any means of hardware and/or software, being executed by controller 20, capable of recognizing points-of-interest when the mobile terminal 10 is pointed at POIs, when the POIs are in the line of sight of the camera module 36, or when the POIs are captured in an image by the camera module, as described more fully in the '733 application. The mobile visual search engine 97 may also be capable of receiving location and position information of the mobile terminal 10 as well as the position of POIs. The mobile visual search engine 97 may further be capable of recognizing or identifying POIs and enabling a user of the mobile terminal 10 to select from a list of several actions that are relevant to a respective POI. For example, one of the actions may include but is not limited to searching for other similar POIs (i.e., candidates) within a geographic area. These similar POIs may be stored in a user profile in the mapping module 99. Additionally, in one exemplary embodiment, the mapping module 99 may launch a third person map view and a first person camera view of the camera module 36. The camera view when executed shows the surrounding area of the mobile terminal 10 and superimposes a set of visual tags that correspond to a set of POIs.

According to one exemplary embodiment, the visual search client 68, may further include a motion and/or image quality monitor 92 for monitoring the quality of an image captured by the camera module 36 as determined, for example, by the relative change in image features resulting from motion and/or other environmental changes. Where, for example, a substantial amount of change (e.g., motion) is detected, causing the image quality to be poor, the captured image may not be used by the visual search engine 97 to locate POIs and provide the user with feedback associated with those POIs. Alternatively, or in addition, as discussed in more detail below, a determination that a significant amount (or some predetermined amount) of motion or change has occurred, may result in some other action being taken with respect to the mobile terminal 10 and/or the camera module 36 (e.g., turn off the camera module 36, turn off a backlight, switch the input method for the visual search client, etc.). The motion and/or image quality monitor 92 of exemplary embodiments may, therefore, include any means of hardware and/or software, being executed by controller 20, capable of determining the relative motion and/or image quality of a captured image and responding accordingly.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

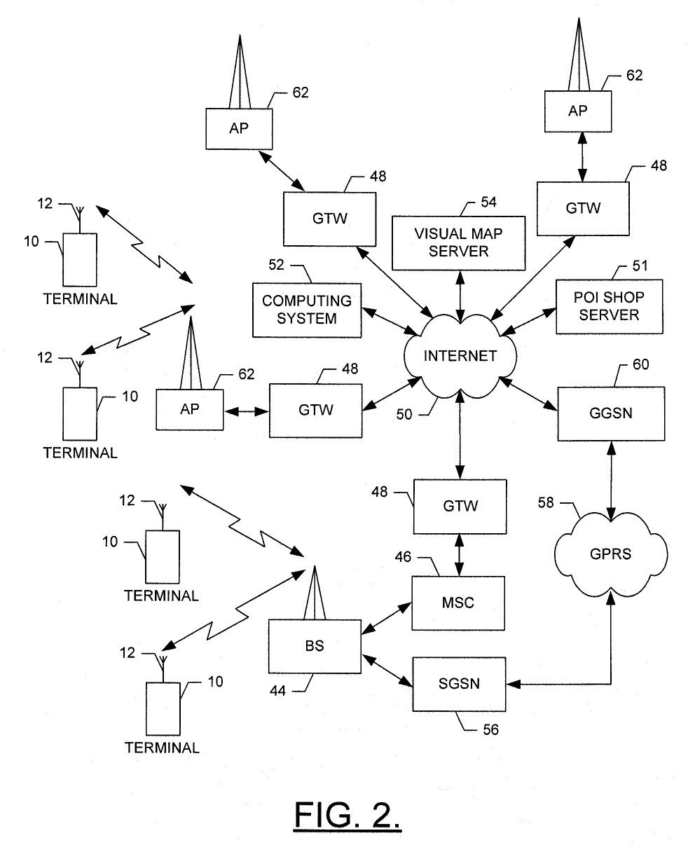

Referring now to FIG. 2, an illustration of one type of system that would benefit from exemplary embodiments of the present invention is provided. The system may include a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52, visual map server 54, point-of-interest shop server 51, or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or visual map server 54 may be coupled to the mobile terminal 10 via the Internet 50, SGSN 56 and GGSN 60. In this regard, devices such as the computing system 52 and/or visual map server 54 may communicate with the mobile terminal 10 across the SGSN 56, GPRS core network 58 and the GGSN 60. By directly or indirectly connecting mobile terminals 10 and the other devices (e.g., computing system 52, visual map server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

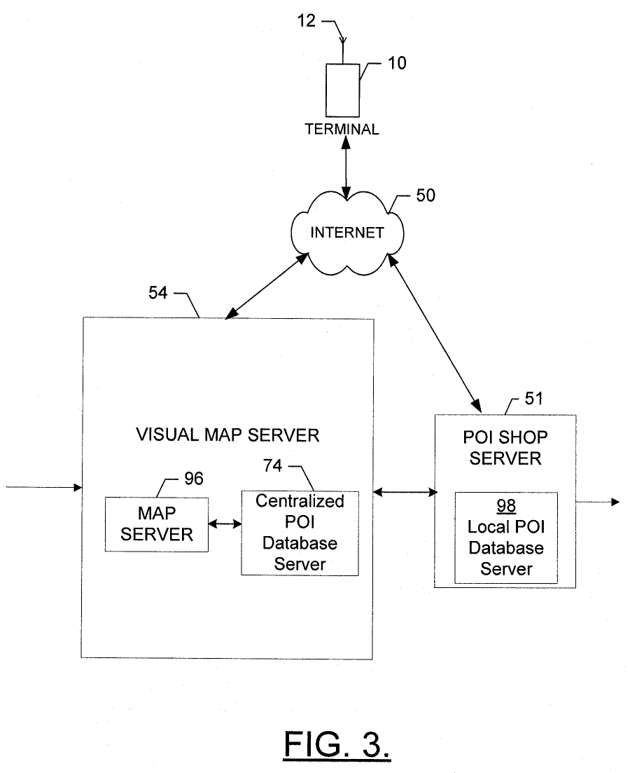

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), Wibree, infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10, the computing system 52, the visual map server 54, and/or any of a number of other devices to the Internet 50, the mobile terminals 10 can communicate with one another, the computing system 52, the visual map server 54, the POI shop server 51, or other devices, to thereby carry out various functions of the mobile terminals 10, such as to transmit data, content or the like to, and/or receive content, data or the like from, the computing system 52, visual map server 54 and/or POI shop server 51. For example, the visual map server 54, may provide map data, by way of a map server 96 (shown in FIG. 3), relating a geographical area of one or more mobile terminals 10 or one or more POIs. Additionally, the visual map server 54 may perform comparisons with images or video clips taken by the camera module 36 and determine whether these images or video clips are stored in the visual map server 54. Furthermore, the visual map server 54 may store, by way of a centralized POI database server 74 (shown in FIG. 3), various types of information relating to one or more POIs that may be associated with one or more images or video clips which are captured by the camera module 36.

The information relating to one or more POIs may be linked to one or more visual tags which may be transmitted to a mobile terminal 10 for display. Moreover, the point-of-interest shop server 51 may store data regarding the geographic location of one or more POI shops and may store data pertaining to various points-of-interest including but not limited to location of a POI, category of a POI, (e.g., coffee shops or restaurants, sporting venue, concerts, etc.) product information relative to a POI, and the like. The visual map server 54 may transmit and receive information from the point-of interest shop server 51 and communicate with a mobile terminal 10 via the Internet 50. Likewise, the point-of-interest shop server 51 may communicate with the visual map server 54 and alternatively, or additionally, may communicate with the mobile terminal 10 directly via a WLAN, Bluetooth, Wibree or the like transmission or via the Internet 50. As used herein, the terms “images,” “video clips,” “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing system 52, visual map server 54 and/or POI shop server 51 across the Internet 50, the mobile terminal 10 and computing system 52, visual map server 54 and/or POI shop server may be coupled to one another and communicate in accordance with, for example, RF, BT, IrDA or any of a number of different wireline or wireless communication techniques, including LAN, WLAN, WiMAX and/or UWB techniques. One or more of the computing systems 52, visual map server 54 and/or POI shop server can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, visual map server 54 and/or POI shop server, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

An exemplary mobile visual search application implemented by a visual search system will now be described with reference to FIG. 3. In this example, the mobile visual search application operates in conjunction with the visual search system shown in FIG. 3 in order to improve an online mapping application. As will be understood by those of ordinary skill in the art, exemplary embodiments of the present invention may be implemented in connection with any camera application that uses image matching or recognition in order to improve upon the results achieved by the executed application. The mobile visual search application and visual search system described herein provide just one example of such a camera application and, therefore, should not be taken as limiting the scope of exemplary embodiments of the present invention. In addition, some of the elements of the visual search system of FIG. 3 may be employed, for example, on the mobile terminal 10 of FIG. 1. However, it should be noted that the system of FIG. 3 may also be employed on a variety of other devices, both mobile and fixed, and therefore, exemplary embodiments of the present invention should not be limited to application on devices such as the mobile terminal 10 of FIG. 1. Thus the description below is given by way of example and not of limitation. For example, the visual search system of FIG. 3 may be employed on a camera, a video recorder, or the like. Furthermore, the system of FIG. 3 may be employed on a device, component, element or module of the mobile terminal 10.

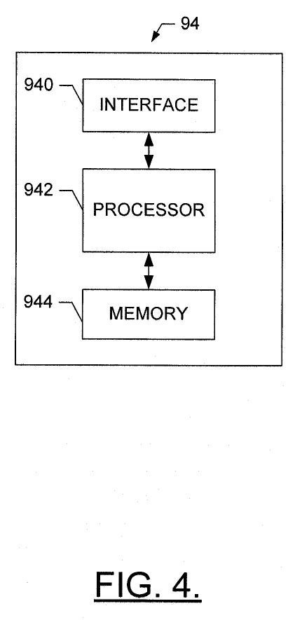

Referring now to FIG. 3, a visual search system for improving an online mapping application that is integrated with a mobile visual search application (i.e., hybrid) according to one exemplary embodiment is provided. As shown, the system may include the visual map server 54, discussed above, in communication with a mobile terminal 10 as well as the point-of-interest shop server 51, also discussed above. The visual map server 54 may be any device or means such as hardware or software capable of storing images or video clips, as well as map data and POI data and visual tags. In one exemplary embodiment, the visual mobile server 54 may include a map server 96 for storing the map data, as well as a centralized POI database server 74 for storing the POI data and visual tags. Moreover, the visual map server 54 may include a processor for carrying or executing these functions including execution of the software. (See e.g. FIG. 4) The images or video clips may correspond to a user profile that is stored on behalf of a user of a mobile terminal 10. Additionally, the images or video clips may be linked to positional information pertaining to the location of the object or objects captured in the image(s) or video clip(s).

Similarly, the point-of-interest shop server 51 may be any device or means such as hardware or software capable of storing information pertaining to points-of-interest. The point-of-interest shop server 51 may include a processor for carrying out or executing functions or software instructions. (See e.g. FIG. 4) The images or video clips may correspond to a user profile that is stored on behalf of a user of a mobile terminal 10. This point-of-interest information may be loaded in a local POI database server 98 (also referred to herein as a visual search advertiser input control/interface) and stored on behalf of a point of interest shop server 51 (for e.g., coffee shops, restaurants, stores, etc.) and various forms of information may be associated with the POI information such as position, location or geographic data relating to a POI, as well, for example, product information including but not limited to identification of the product, price, quantity, etc. The local POI database server 98 (i.e., visual search advertiser input control/interface) may be included in the point-of-interest shop server 51 or may be located external to the POI shop server 51.

In the exemplary embodiment of the visual search system of FIG. 3, in order to use the mobile visual search application, a user of a mobile terminal 10 may launch the visual search client 68 (e.g., using keypad 30 or alternatively by using menu options shown on the display 28), point the camera module 36 at a point-of-interest such as for example, a coffee shop, and capture an image of the coffee shop. The mobile visual search module 97 (of the visual search client 68) may invoke a recognition scheme to thereby recognize the coffee shop and allow the user to select from a list of several actions, displayed on display 28 that are relevant to the given POI, in this example the coffee shop. For example, one of the relevant actions may be to search for other similar POIs (e.g. other coffee shops) (i.e., candidates or candidate POIs). In response to the user selecting this action, the visual search client 68 may transmit the captured image of the coffee shop to the visual map server 54 and the visual map server 54 may find and locate other nearby coffee shops in the centralized POI database server 74. The visual map server 54 may also retrieve from map server 96 an overhead map of the surrounding area which includes superimposed visual tags corresponding to other coffee shops (or any physical entity of interest to the user) relative to the captured image of the coffee shop. The visual map server 54 may transmit this overhead map to the mobile terminal 10, which displays the overhead map of the surrounding area including the superimposed visual tags corresponding to other POIs (e.g. other coffee shops). The user can then use a joystick, arrows, buttons, stylus or other input modalities known to those skilled in the art on the keypad 30 to obtain more information pertaining to other nearby tags on the map

Referring to FIG. 4, a block diagram of a server 94 capable of operating the POI shop server 51, the local POI database server 98, the centralized POI database server 74, the map server 96 and/or the visual map server 54 discussed above, is shown. As shown in FIG. 4, in one exemplary embodiment the server 94 is capable of allowing a user, such as a product manufacturer, product advertiser, business owner, service provider, network operator, or the like, to input relevant information (e.g., via the interface 940) relating, for example, to a POI. The information, which may then be stored in the memory 944, may include, for example, web pages, web links, yellow pages information, images, videos, contact information, address information, positional information such as waypoints of a building, locational information, map data and the like. The server 94 generally includes a processor 942, controller or the like connected to the memory 944. The processor can also be connected to at least one interface 940 or other means for transmitting and/or receiving data, content or the like. The memory can comprise volatile and/or non-volatile memory, and typically stores content relating to one or more POIs, as noted above. The memory 944 may also store software applications, instructions or the like for the processor to perform steps associated with operation of the server in accordance with embodiments of the present invention. In this regard, the memory may contain software instructions (that are executed by the processor) for storing, uploading/downloading POI data, map data and the like and for transmitting/receiving the POI data to/from mobile terminal 10 and to/from the point-of-interest shop server as well as the visual search server.

### Motion & Image Quality Monitor

As discussed above, exemplary embodiments of the present invention provide a motion and image quality monitor for monitoring the quality of images captured by the camera module 36 and used, for example, in the mobile visual search, or similar image matching or recognition, application discussed above. In one exemplary embodiment as shown in FIG. 1 above, the motion and image quality monitor 92 may reside on the mobile device and operate in conjunction with the visual search client 98 also discussed above. However, as one of ordinary skill in the art will recognize, the monitor may alternatively reside on any entity of a visual search, or similar image matching, system wherein such monitoring may take place. In addition, it is not necessary that the mobile device 10 perform the motion and image quality monitoring described herein. Alternatively, in one exemplary embodiment, an entity of the visual search, or similar image matching, system may perform the monitoring for the mobile device.

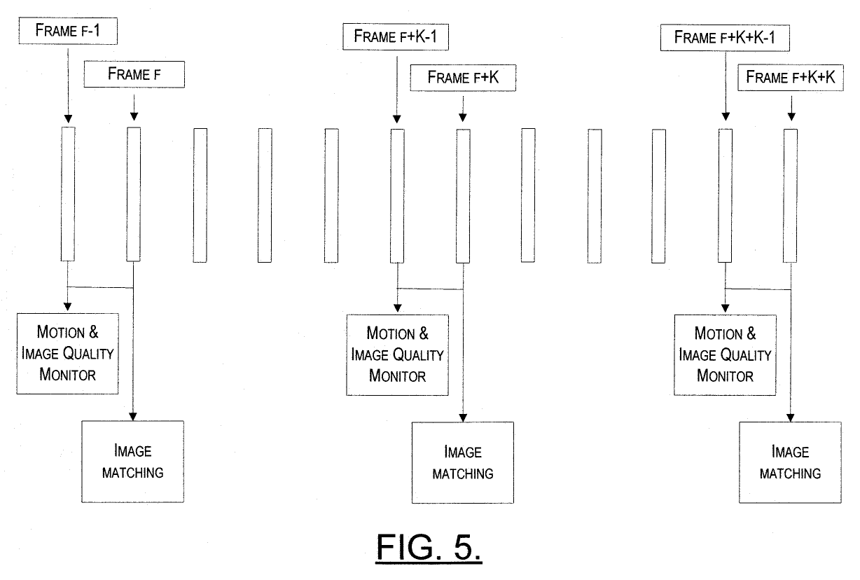

The following describes one exemplary method for performing the above-described monitoring in connection with FIGS. 5-9D. As one of ordinary skill in the art will recognize, the following is just one example of a method that may be used for monitoring motion and/or image quality, and other methods may similarly be used without departing from the spirit and scope of exemplary embodiments of the present invention. As shown in FIG. 5, in one exemplary embodiment, a captured image or video may be sampled every K-th frame (i.e., Frame F, Frame F+K, etc.), for example, for the purpose of image matching with images of a visual database, wherein F and K are positive integers. Another sample may also be taken just before the K-th frame (i.e., Frame F-1, Frame (F+K-1), etc.). This second sampled frame may thereafter be combined with the K-th frame, as described below, in order to monitor motion and image quality changes. Because in at least one embodiment, the K-th frame is already being sampled for the purpose of image matching, by using this sampled frame to perform the monitoring, the motion and image quality monitor of exemplary embodiments may be designed to work together with the image matching system, thus minimizing additional computations and overhead.

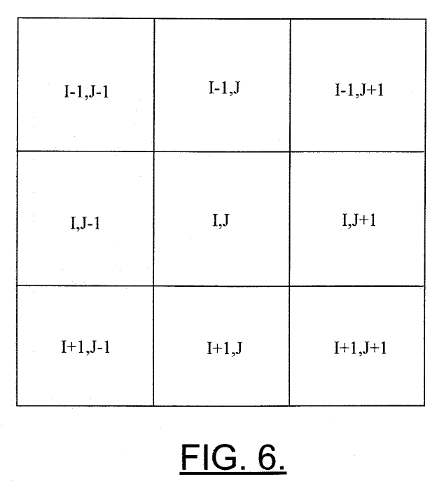

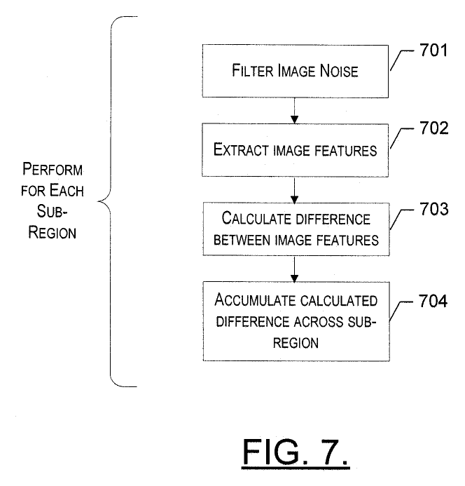

Each input image or video frame sampled may then be divided into a grid including a plurality of sub-regions, as shown in FIG. 6. While not necessary, division into sub-regions provides for a more robust detection of motions. The steps which may be taken in order to analyze each sub-region of the grid are illustrated in FIG. 7. As shown, sub-regions may first be filtered in order to remove noise. (Step 701). The image features may then be extracted from the sub-regions (Step 702), and the difference between the image frames (i.e., the K-th frame and the (K-1)th frame) may be computed (Step 703) and accumulated over the whole sub-region (Step 704). According to one exemplary embodiment, the comparison of image features includes comparing various features that are already being used in the image matching engine (e.g., for matching the captured image to images and information stored in the visual database). As a result, the processing time, as well as the cost associated with monitoring the motion and image quality changes can be reduced substantially, since the image features in one of the frames (e.g., the K-th frame) can be directly used by the image matching engine.

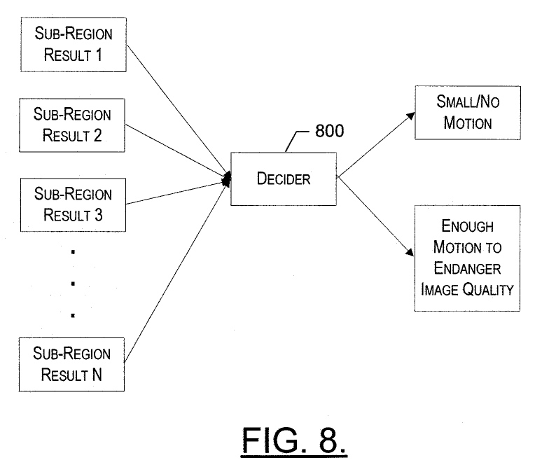

Turning now to FIG. 8, after accumulating the computed differences within each sub-region, the sub-region results may then be integrated in order to robustly detect motion and image quality changes. Integrating the results may include, for example, computing the number of sub-regions having detected motion that exceeds some predetermined threshold and/or computing the a weighted percentage change of sub-regions, both of which affect the overall assessment of motion in the frame. While not necessary, through use of this integration approach, exemplary embodiments of the present invention are more robust against image noises, such as still image frames with moving objects, lighting changes in the scene, and/or low-textured backgrounds. In particular, by dividing the frame into sub-regions and then integrating the results of each sub-region, motion resulting from camera movement can be distinguished from motion occurring in the captured scene (e.g., a moving car). This is due to the fact that motion occurring in the scene may only be detected in a subset of the sub-regions, whereas motion due to camera movement would likely occur in all of the sub-regions. Returning to FIG. 8, as shown, the output of the integrator or “decider” 800 may be that a small amount of motion or no motion is detected within the frame, or that there is a sufficient amount of motion to endanger the image quality. As one of ordinary skill in the art will recognize, the decider 800 may comprise any means such as hardware or software, or a combination of hardware and software, configured, for example, to integrate the results of the various sub-regions and then compare the integrated results to a predetermined threshold to determine whether the amount of motion is significant enough to warrant some sort of action being taken. Alternatively, the decider may first compare the results of each sub-region to a predetermined threshold prior to integration.

As noted above, the foregoing is just one method that may be used to detect motion and ascertain image quality and other, similar, methods may likely be used without departing from the spirit and scope of exemplary embodiments of the present invention. For example, according to one exemplary embodiment, the mobile device may include an acceleration sensor capable of detecting acceleration along a certain axis (e.g., x, y or z axis). Motion may be detected based on a threshold of acceptable versus unacceptable acceleration, as detected by the acceleration sensor. In this exemplary embodiment, consecutive frames need not be analyzed and instead, a threshold of maximum allowed motion may be set.

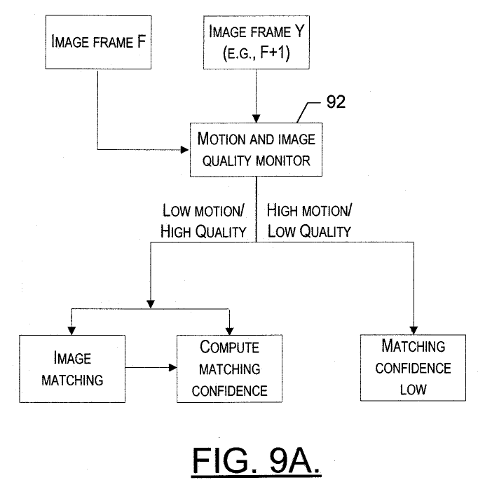

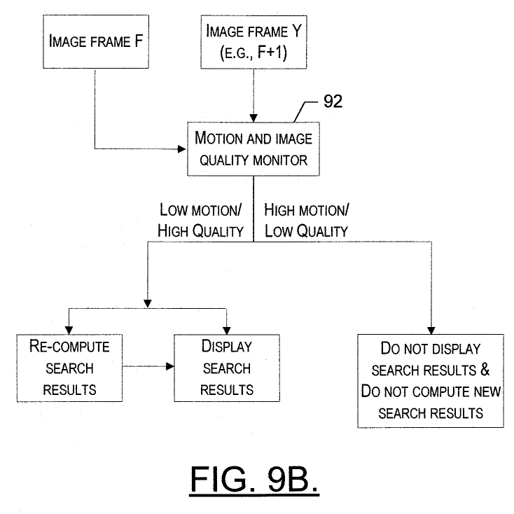

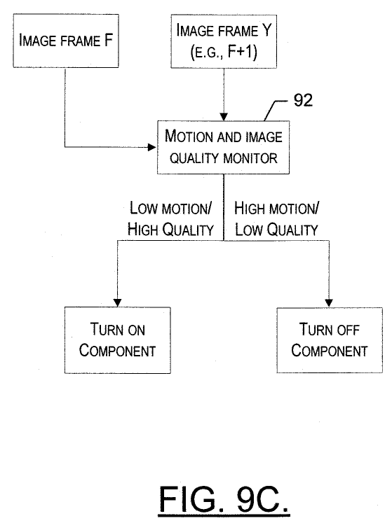

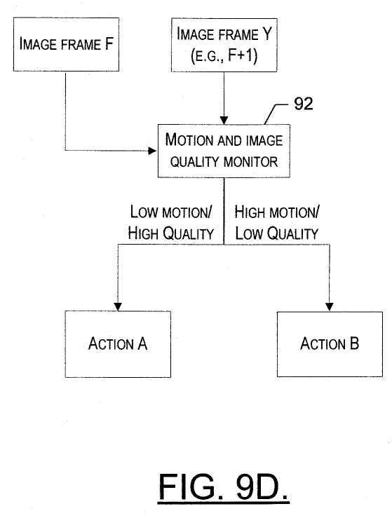

As discussed above, the mobile device of exemplary embodiments may take one or more of several actions in response to the detection of poor image quality or significant amounts of change or motion between image frames. FIGS. 9A through 9D illustrate just a few of these possible actions or responses. As shown in FIG. 9A, which illustrates the embodiment wherein the motion and image quality monitor is acting in conjunction with an image matching system, where motion or quality change is detected, and the quantity of image quality change is large, the overall image matching system may output low image matching confidence, and no image matching may be performed. In contrast, where only a small motion and quality change is detected, and the quantity is small enough that the input image quality is not endangered, the image matching may be conducted, and image matching confidence may be computed and output to a screen or display of the mobile device. In this manner, the motion and image quality monitor acts to stabilize the captured image prior to use in conjunction with the image matching system.

Where, for example, the image matching application is a mobile visual search application of the kind discussed above, in one exemplary embodiment (shown in FIG. 9B), if there is high motion and/or low image quality detected, the visual search system may be instructed to maintain the existing search results (“cache”) forever or until a certain threshold is reached or surpassed (e.g. a difference in any image-related measure, a difference in time, or a difference in any other context as provided in the visual search system). In one exemplary embodiment, no search results may be displayed to the user. Alternatively, only part of the existing search results may be displayed. In addition, in one exemplary embodiment, a visualization (e.g., a text message or display) may be displayed indicating that no results, or only part of the results, are being displayed. If, on the other hand, there is low motion and/or high image quality detected (e.g., as determined by a certain threshold, such as a percentage change in a particular image feature between frames, being reached or surpassed), the visual search system may execute a new image matching to update the results.

As shown in FIGS. 9C and 9D, respectively, a determination may likewise be made as to whether to turn off or on a particular component of the mobile device, or whether to take, or continue to maintain, a particular action (e.g., Action A) or another action (e.g., Action B). Components that may be turned on or off may include, for example, a backlight, the camera, the processor, or any other hardware component associated with the mobile device or camera module. In one exemplary embodiment, the component may be turned off forever or until a certain threshold (e.g., a percentage change in a captured image feature) is reached or surpassed. For example, in one exemplary embodiment, motion detection may be used in order to turn off a screen backlight in a large and continuous motion in order to save energy consumption of mobile devices.

Actions that may be taken, in accordance with FIG. 9D, may, for example, include displaying results, computing results, turning off a sub-component, switching applications, switching application modes, switching input methods (e.g., voice recognition, image, motion or text entry, etc.), or any other type of action.

As will be understood by one of ordinary skill in the art, where a decision is made to turn off a particular device, or switch to a particular application or to a particular input method, or the like, when the motion detected is high and/or the image quality determined is low (e.g., as compared to some predefined threshold value), an opposite decision may likewise be made when the outcome of the motion and image quality monitor is that the motion detected is low and/or the image quality determined is high.

According to another exemplary embodiment, the mobile device may further be capable of detecting when the mobile device has been put away, for example, in a pocket or a handbag. In particular, according to this exemplary embodiment, the mobile device may be configured to analyze the level of ambient light that the camera module is receiving. Where, for example, there is an insufficient amount of light to recognize objects in the line of sight of the cameral module, the mobile device may assume that the device is in a pocket or handbag and go to sleep. The mobile device may, thereafter, wake up in intervals to try to figure out whether the camera can see something meaningful. The foregoing is beneficial since placing a mobile device in one's pocket and forgetting to turn it off can drain the battery of the mobile device sooner than expected.

### Conclusion:

The system, method, electronic device and computer program product of exemplary embodiments of the present invention are primarily described in conjunction with mobile communications applications. It should be understood, however, that the system, method, electronic device and computer program product of embodiments of the present invention can be utilized in conjunction with a variety of other applications, both in the mobile communications industries and outside of the mobile communications industries. For example, the system, method, electronic device and computer program product of exemplary embodiments of the present invention can be utilized in conjunction with wireline and/or wireless network (e.g., Internet) applications.

As described above and as will be appreciated by one skilled in the art, embodiments of the present invention may be configured as a system, method, or electronic device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of monitoring motion and image quality of a captured image, said method comprising:
detecting motion in a captured image; and
taking an action in response to the motion detected, wherein the action comprises stabilizing the captured image prior to using the captured image in an image matching application or conserving power in response to the motion detected exceeding a predetermined threshold.

2. The method of claim 1, wherein detecting motion in a captured image comprises comparing one or more features of two or more consecutive frames of the captured image.

3. The method of claim 2, wherein the features compared are selected from a set of features used for the image matching application.

4. The method of claim 2, wherein comparing one or more features further comprises:
sampling two or more frames of the captured image;
filtering the two or more sampled frames to remove noise;
extracting the one or more features from the sampled frames; and
computing a difference between the extracted features of the sampled frames.

5. The method of claim 4, wherein comparing one or more features further comprises:
dividing respective sampled frames into two or more sub-regions, wherein filtering the two or more sampled frames comprises filtering respective sub-regions of the sampled frames, extracting the one or more features from the sampled frames comprises extracting the one or more features from respective sub-regions of the sampled frames, and computing a difference between the extracted features comprises computing the difference between extracted features for respective sub-regions of the sampled frames;
accumulating the computed difference between extracted features for respective sub-regions; and
integrating the accumulated differences of the two or more sub-regions.

6. The method of claim 1, wherein detecting motion in a captured image comprises:
detecting an amount of acceleration associated with a captured image; and
comparing the detected acceleration to a predetermined threshold.

7. The method of claim 1, wherein stabilizing the captured image prior to using the captured image in an image matching application further comprises:
determining whether the detected motion exceeds a predetermined threshold; and
preventing the captured image from being used by the image matching application where the detected motion exceeds the predetermined threshold.

8. The method of claim 7, wherein the image matching application comprises a mobile visual search application, and wherein preventing the captured image from being used by the image matching application comprises instructing the mobile visual search application not to generate new search results based on the captured image.

9. The method of claim 1, wherein conserving power further comprises turning off one or more components of an electronic device used to capture the image when the motion detected exceeds the predetermined threshold.

10. The method of claim 1, wherein the action is selected from a group consisting of: when the motion detected exceeds a predetermined threshold, preventing the image matching application from using the captured image, instructing a mobile visual search application not to generate new search results based on the captured image, turning off one or more components of an electronic device used to capture the image, switching from a first application operating on the electronic device to a second application, changing a mode of operation of an application operating on the electronic device, and changing an input method of an application operating on the electronic device.

11. An apparatus for monitoring motion and image quality of a captured image, said apparatus comprising:
a processor; and
a memory in communication with the processor and storing an application executable by the processor, wherein the application is configured, upon execution, to detect motion in a captured image, and cause an action to be taken in response to the motion detected, wherein the action comprises stabilizing the captured image prior to using the captured image in an image matching application or conserving power in response to the motion detected exceeding a predetermined threshold.

12. The apparatus of claim 11, wherein in order to detect motion in a captured image, the application is further configured, upon execution, to compare one or more features of two or more consecutive frames of the captured image.

13. The apparatus of claim 12, wherein in order to compare one or more features of the two or more consecutive frames, the application is further configured, upon execution, to:
sample two or more frames of the captured image;
filter the two or more sampled frames to remove noise;
extract the one or more features from the sampled frames; and
compute a difference between the extracted features of the sampled frames.

14. The apparatus of claim 13, wherein in order to compare one or more features of the two or more consecutive frames, the application is further configured, upon execution, to:
divide respective sampled frames into two or more sub-regions, wherein filtering the two or more sampled frames comprises filtering respective sub-regions of the sampled frames, extracting the one or more features from the sampled frames comprises extracting the one or more features from respective sub-regions of the sampled frames, and computing a difference between the extracted features comprises computing the difference between extracted features for respective sub-regions of the sampled frames;
accumulate the computed difference between extracted features for respective sub-regions; and
integrate the accumulated differences of the two or more sub-regions.

15. The apparatus of claim 11, wherein in order to detect motion in a captured image, the application is further configured, upon execution, to:
detect an amount of acceleration associated with a captured image; and
compare the detected acceleration to a predetermined threshold.

16. The apparatus of claim 11, wherein in order to cause the captured image to be stabilized prior to using the captured image in an image matching application, the application is further configured, upon execution, to:
determine whether the detected motion exceeds a predetermined threshold; and
prevent the captured image from being used by the image matching application where the detected motion exceeds the predetermined threshold.

17. The apparatus of claim 16, wherein the image matching application comprises a mobile visual search application, and wherein in order to prevent the captured image from being used by the image matching application, the application is further configured, upon execution, to instruct the mobile visual search application not to generate new search results based on the captured image.

18. The apparatus of claim 11, wherein the image matching application is stored on the memory and executable by the processor.

19. The apparatus of claim 11, wherein in order to cause power to be conserved, the application is further configured, upon execution, to turn off one or more components of the apparatus when the motion detected exceeds the predetermined threshold.

20. The apparatus of claim 11 further comprising:
a camera module operable by the processor and configured to capture one or more images, said memory configured to store the one or more captured images.

21. A computer program product for monitoring motion and image quality of a captured image, wherein the computer program product comprises at least one computer-readable storage medium having computer-readable program code portions stored therein, the computer-readable program code portions comprising:
a first executable portion for detecting motion in a captured image; and
a second executable portion for causing an action to be taken in response to the motion detected, wherein the action comprises stabilizing the captured image prior to using the captured image in an image matching application or conserving power in response to the motion detected exceeding a predetermined threshold.

22. The computer program product of claim 21, wherein the first executable portion is configured to compare one or more features of two or more consecutive frames of the captured image.

23. The computer program product of claim 22, wherein in order to compare one or more features of two or more consecutive frames, the first executable portion is further configured to:
sample two or more frames of the captured image;
filter the two or more sampled frames to remove noise;
extract the one or more features from the sampled frames; and
compute a difference between the extracted features of the sampled frames.

24. The computer program product of claim 23, wherein in order to compare one or more features of two or more consecutive frames, the first executable portion is further configured to:
divide respective sampled frames into two or more sub-regions, wherein filtering the two or more sampled frames comprises filtering respective sub-regions of the sampled frames, extracting the one or more features from the sampled frames comprises extracting the one or more features from respective sub-regions of the sampled frames, and computing a difference between the extracted features comprises computing the difference between extracted features for respective sub-regions of the sampled frames;
accumulate the computed difference between extracted features for respective sub-regions; and
integrate the accumulated differences of the two or more sub-regions.

25. The computer program product of claim 21, wherein the first executable portion is configured to:
detect an amount of acceleration associated with a captured image; and
compare the detected acceleration to a predetermined threshold.

26. The computer program product of claim 21, wherein in order to cause the captured image to be stabilized prior to using the captured image in an image matching application, the second executable portion is further configured to:
determine whether the detected motion exceeds a predetermined threshold; and
prevent the captured image from being used by the image matching application where the detected motion exceeds the predetermined threshold.

27. The computer program product of claim 26, wherein the image matching application comprises a mobile visual search application, and wherein in order to prevent the captured image from being used by the image matching application, the second executable portion is further configured to instruct the mobile visual search application not to generate new search results based on the captured image.

28. The computer program product of claim 21, wherein in order to cause the power to be conserved, the second executable portion is further configured to turn off one or more components of an electronic device used to capture the image when the motion detected exceeds the predetermined threshold.

29. An apparatus for monitoring motion and image quality of a captured image, said apparatus comprising:
means for detecting motion in a captured image; and
means for taking an action in response to the motion detected, wherein the action comprises stabilizing the captured image prior to using the captured image in an image matching application or conserving power in response to the motion detected exceeding a predetermined threshold.
